(19) United States
(12) Patent Application Publication
(10) Pub. No.: US 2025/0166296 A1
(43) Pub. Date: May 22, 2025

(54) COMPUTER PROGRAM PRODUCT FOR 3D MODELING AND MOVING-OBJECT ELIMINATION METHOD THEREOF

(71) Applicant: Delta Electronics, Inc., Taoyuan City (TW)

(72) Inventors: Ting-Wei CHANG, Taoyuan City (TW); Kual-Zheng LEE, Taoyuan City (TW); Tzu-Yang LIN, Taoyuan City (TW)

(21) Appl. No.: 18/895,711

(22) Filed: Sep. 25, 2024

(30) Foreign Application Priority Data
Nov. 22, 2023 (TW) 112145136

(51) Int. Cl. G06T 17/00; G06T 5/50; G06T 7/11; G06T 7/246; G06V 10/44; G06V 10/46; G06V 10/75

(52) U.S. Cl. CPC G06T 17/00; G06T 5/50; G06T 7/11; G06T 7/246; G06V 10/44; G06V 10/462; G06V 10/751; G06T 2207/20221

(57) ABSTRACT

A moving-object elimination method for 3D modeling, including the following steps. The method includes detecting a plurality of feature points in each original image in a sequence of original images through a feature point detection process. The method includes detecting a plurality of feature points in each original image through a feature point detection process. The method includes dividing each original image into a plurality of regions through a region segmentation process. The method includes determining a target region and one or more non-target regions from the regions of each original image. The method includes determining whether each of the non-target regions of two consecutive frames is a moving-object region through a feature-point matching process based on the feature points. The method includes replacing, for each original image, the non-target regions determined as moving-object regions with a featureless region, to obtain a sequence of static images.

### CROSS REFERENCE TO RELATED APPLICATIONS

This application claims priority of Taiwan Patent Application No. 112145136, filed on Nov. 22, 2023, the entirety of which is incorporated by reference herein.

### BACKGROUND OF THE INVENTION

### Field of the Invention

The present invention relates to 3D modeling technology, and, in particular, to a computer program product for 3D modeling and a moving-object elimination method thereof.

### Description of the Related Art

Unmanned Aerial Vehicles (UAVs) possess the capability to overcome terrain constraints in order to execute missions. They can also assist personnel in task execution to effectively enhance efficiency. Consequently, the market for UAVs has thrived in recent years. The known applications of UAVs have developed rapidly in areas such as construction, engineering, mining, energy, transportation, public facilities, and precision agriculture. Particularly noteworthy is the prevalent use of UAVs for 3D modeling of topography, scenery, and architecture in recent years, making it a mainstream application.

The use of UAVs in 3D modeling involves equipping an unmanned aerial vehicle with a high-resolution camera to capture consecutive images of stationary objects or scenes from different angles in various locations. The feature points in these images are used to determine the 3D coordinates of the UAV during the photography process. These coordinates are then used to back-calculate the 3D coordinates of the target objects, thereby constructing a 3D model.

FIG. 1 is a schematic diagram of 3D modeling photography using a UAV. As shown in FIG. 1, the UAV flies from the first position 100 along flight path 102 to the second position 104, and then along flight path 106 to the third position 108. At these three positions, the UAV photographs the target object 110, producing the first image 120, the second image 130, and the third image 140 for modeling. Feature points A 112 and B 114 on the target object 110 are projected onto the first image 120 as points a₁ 122 and b₁ 124, onto the second image 130 as points a₂ 132 and b₂ 134, and onto the third image 140 as points a₃ 142 and b₃ 144, via multiple rays 116. Subsequently, by calculating the feature similarities among the images and performing ray back-projection from multiple perspectives into 3D space, the 3D coordinates of feature points A 112 and B 114 can be determined. These coordinates can then be represented in the form of a 3D point cloud.

The calculation of the aforementioned 3D coordinates relies on the principle that the projections of conjugate points, captured from different angles, should intersect at the same point in 3D space. However, because the photography process takes place over a continuous period of time (taking a 30-meter-long bridge as an example, approximately 10 minutes of photography may be required), the presence of moving objects (such as trains or high-speed rail trains) during the photography process may lead to the failure of the ray projections of these moving objects in different frames to intersect at the correct positions. Consequently, this can introduce noise into the constructed 3D model.

FIG. 2 illustrates the cause of noise in 3D modeling. As shown in FIG. 2, the UAV flies from one position 200 along flight path 202 to another position 204, capturing images at both positions, resulting in the first image 214 and the second image 224 for modeling. During this period, the object moves from point A 210 to point A′ 220. Before the UAV moves, point A 210 is projected onto the first image 214 as point a 216 via ray 212. After the UAV moves, point A′ 220 is projected onto the second image 224 as point a′ 226 via ray 222. Based on the principles of 3D modeling mentioned earlier, since the image features of points a 216 and a′ 226 are similar, their back-projection would intersect in 3D space at a common point A* 230. However, the position of A* 230 corresponds to neither point A 210 nor point A′ 220, resulting in the introduction of noise into the model.

In practical scenarios, it is challenging to restrict objects from entering or exiting the scenes captured by UAV photography. As a result, manual removal of noise is required after 3D modeling to ensure the accuracy of the final 3D model. However, this noise removal process is tedious and time-consuming. Although there are methods for post-processing noise reduction on the 3D model, they rely on the projection relationships established during the initial 3D modeling. Consequently, in certain situations, such methods may fail. For example, if the input images contain moving objects with distinctive appearances (such as oversized objects), there is a high chance of initial modeling errors, which can render the subsequent noise reduction process ineffective.

With the anticipated increase in demand for various types of 3D modeling using UAVs in the future, designing a solution to eliminate moving objects in 3D modeling has become an increasingly important issue.

### BRIEF SUMMARY OF THE INVENTION

An embodiment of the present disclosure provides a moving-object elimination method for 3D modeling. The method includes detecting a plurality of feature points in each original image in a sequence of original images through a feature point detection process. The method includes dividing each original image into a plurality of regions through a region segmentation process. The method includes determining a target region and one or more non-target regions from the regions of each original image. The method includes determining whether each of the non-target regions of two consecutive frames of the original images is a moving-object region through a feature-point matching process based on the feature points in the two consecutive frames of the original images in the sequence of original images; and replacing, for each original image, the non-target regions determined as moving-object regions with a featureless region, to obtain a sequence of static images.

In an embodiment, the step of determining whether each of the non-target regions of the two consecutive frames of the original images is a moving-object region through the feature-point matching process based on the feature points in the two consecutive frames of the original images in the sequence of original images further includes: obtaining a plurality of matching pairs of feature points through the feature-point matching process based on the feature points in the two consecutive original images; determining a transformation matrix based on the matching pairs in the target region of the two consecutive frames of original images; calculating an average projection error for each of the non-target regions of the two consecutive frames of the original image based on the matching pairs in the non-target region and the transformation matrix; and determining, for each of the non-target regions of the two consecutive original images, whether the non-target region is a moving-object region, by comparing the average projection error with a threshold.

In an embodiment, before determining the transformation matrix, the method further includes: examining the homography relationship of the target region in the two consecutive original images based on the number of matching pairs in the target region of the two consecutive original images.

In an embodiment, the step of calculating the average projection error for each of the non-target regions of the two consecutive frames of the original image based on the matching pairs in the non-target region and the transformation matrix further includes the following steps. For each of the matching pairs in the non-target region, the transformation matrix is used to project the first feature point in the matching pair to a projection point, and to calculate the Euclidean distance between the projection point and the second feature point in the matching pair. The average of the Euclidean distances of the matching pairs is calculated and used as the average projection error.

In an embodiment, before comparing the average projection error with the threshold, the method further includes calculating the average projection error and the corresponding standard deviation for the target region of the two consecutive original images based on the matching pairs in the target region and the transformation matrix. The method further includes determining the threshold based on the average projection error and the standard deviation of the target region of the two consecutive frames of the original images.

In an embodiment, each feature point has a feature descriptor.

In an embodiment, the feature-point matching process includes comparing the feature descriptors in the two consecutive frames of the original images to obtain a plurality of matching pairs of feature points.

In an embodiment, the feature point detection process includes using a scale-invariant feature transform (SIFT) algorithm.

In an embodiment, the region segmentation process includes using a ViT-Adapter.

In an embodiment, the feature-point matching process includes using a Brute-Force Matcher.

An embodiment of the present disclosure further provides a computer program product for 3D modeling. The computer program product includes a user interface module, a 3D modeling module, and a moving-object elimination module. The user interface module is used for providing a user interface. The 3D modeling module is used for creating a 3D model. The moving-object elimination module is used for executing the moving-object elimination method. When the computer program product is loaded into a computer, the computer is capable of executing the following steps: obtaining a sequence of original images; in response to receiving a moving-object elimination instruction from the user interface, calling the moving-object elimination module to execute the moving-object elimination method, and driving the 3D modeling module to use the sequence of static images obtained by executing the moving-object elimination method to create the 3D model; and in response to receiving a direct modeling instruction from the user interface, driving the 3D modeling module to use the sequence of original images to create the 3D model.

In an embodiment, the user interface is a graphical user interface (GUI) for presenting the region segmentation result of the region segmentation process and enabling the user of the computer to select the target region on the segmentation result.

In an embodiment, the moving-object elimination module further detects the area proportion of the moving-object region in the sequence of original images, and checks the number of original images in the original image sequence that are determined to be without the moving-object regions. In response to the area proportion of the moving-object region in the sequence of original images exceeding a first specified threshold, and the number of original images in the original image sequence that are determined to be without moving-object regions being below a second specified threshold, the moving-object elimination module notifies the user interface module to present an exception message in the user interface.

Another embodiment of the present disclosure further provides a computer program product for 3D modeling. When loaded into a computer, the computer program product provides a graphical user interface (GUI). The GUI includes an image importing section, a moving-object elimination section, and a modeling section. The image importing section enables the user to input a specified path to import an original image sequence. The moving-object elimination section enabling the user to input an elimination instruction. The modeling section enables the user to input a modeling instruction. In response to receiving the elimination instruction, the computer program product causes the computer to execute a moving-object elimination method on the original image sequence to obtain a static image sequence. In response to receiving the modeling instruction, the computer program product causes the computer to select, based on the elimination instruction, either the original image sequence or the static image sequence, for use in creating a 3D model.

In an embodiment, the GUI further includes an elimination progress display section, for presenting the processing progress of the moving-object elimination method.

In an embodiment, the GUI further includes a target region selection section, presenting the region segmentation result and enabling the user to select a target region on the region segmentation result.

In an embodiment, the GUI further includes an image display section, presenting the original image sequence, the static image sequence, or both.

In an embodiment, the GUI further includes elimination result display section. In response to the area proportion of a moving-object region in the original image sequence exceeding a first specified threshold, and the number of original images in the original image sequence that are determined to be without moving-object regions being below a second specified threshold, the elimination result display section presents an exception message. In response to obtaining the static image sequence, the elimination result display section presents a success message.

In an embodiment, after the exception message is presented, the GUI further includes a manual elimination section, enabling the user to manually eliminate the moving objects.

In an embodiment, the exception message is configured to guide the user to add more original images to the original image sequence.

The various embodiments disclosed herein provide a solution for eliminating moving objects in 3D modeling, with spatial (object) and temporal (movement) awareness. By selectively eliminating moving objects from images while retaining information about stationary objects, the integrity and accuracy of the 3D model are ensured. Additionally, the disclosed user interface further offers flexibility in enabling or disabling the moving-object elimination process, allows users to select target regions on the region segmentation results, and displays elimination results, providing user interaction features distinct from traditional 3D modeling approaches. In contrast to some post-modeling denoising processes, the embodiments disclosed herein eliminate objects before modeling, further preventing the introduction of noise into the 3D model. The images with moving objects eliminated can be seamlessly integrated into various commercial modeling software, enhancing market applicability.

### BRIEF DESCRIPTION OF THE DRAWINGS

The present disclosure can be more fully understood by reading the subsequent detailed description and examples with references made to the accompanying drawings, wherein:

FIG. 1 is a schematic diagram of using a UAV for 3D modeling photography;

FIG. 2 shows the causes of noise in 3D modeling;

FIG. 3 is a flow chart illustrating a moving-object elimination method for 3D modeling, according to an embodiment of the present disclosure;

FIG. 4 is a schematic diagram showing two frames of the original images captured by a UAV flying from right to left, according to an embodiment of the present disclosure;

FIG. 5 is a schematic diagram showing the feature point detection results of the original image, according to an embodiment of the present disclosure;

FIG. 6 is a schematic diagram showing the region segmentation result of an original image, according to an embodiment of the present disclosure;

FIG. 7 is a schematic diagram showing a feature point matching pair, according to an embodiment of the present disclosure;

FIG. 8 is a flow diagram illustrating more detailed steps of motion region determination, according to an embodiment of the present disclosure;

FIG. 9A and FIG. 9B are conceptual diagrams illustrating the use of the transformation matrix of the target region to determine the moving-object region, according to an embodiment of the present disclosure;

FIG. 10 shows an example of two frames of static images, according to an embodiment of the present disclosure;

FIG. 11 is a system block diagram illustrating a computer system for 3D modeling, according to an embodiment of the present disclosure;

FIG. 12 is a flow diagram illustrating the basic operation of a 3D modeling program, according to an embodiment of the present disclosure;

FIG. 13 is an interface block diagram illustrating the user interface provided by the 3D modeling program when being loaded into a computer, according to an embodiment of the present disclosure; and

FIG. 14 is an illustrative example of the user interface provided by a 3D modeling program when an exception event is triggered.

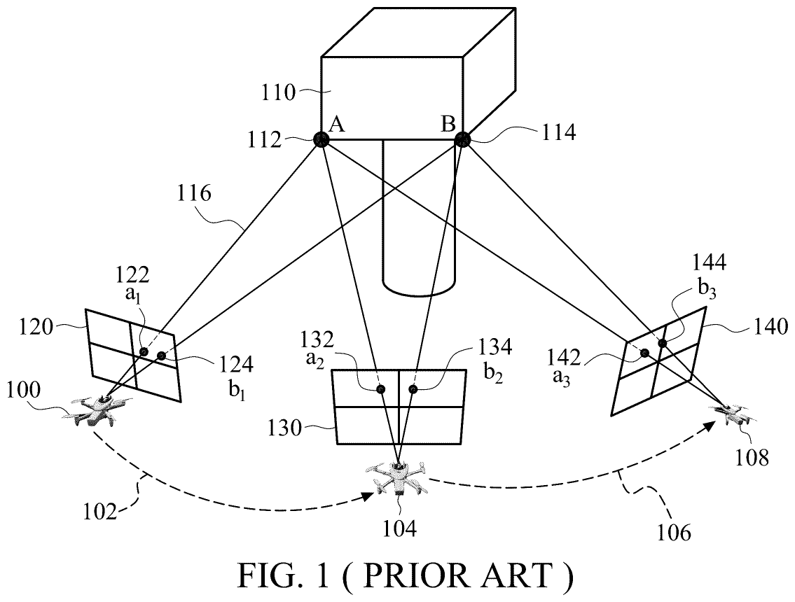

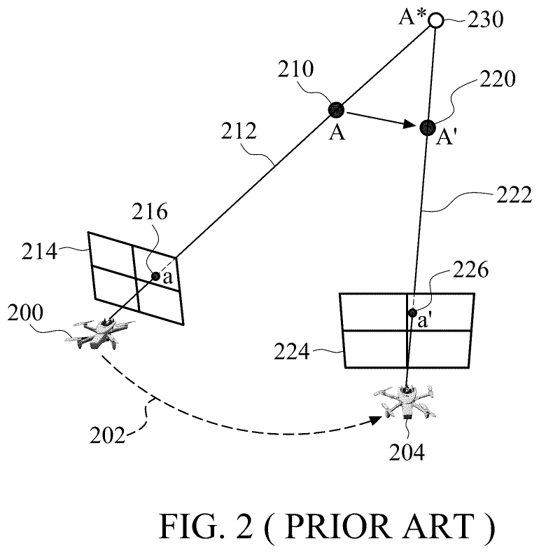

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The descriptions provided below for embodiments of devices or systems are also applicable to embodiments of methods, and vice versa.

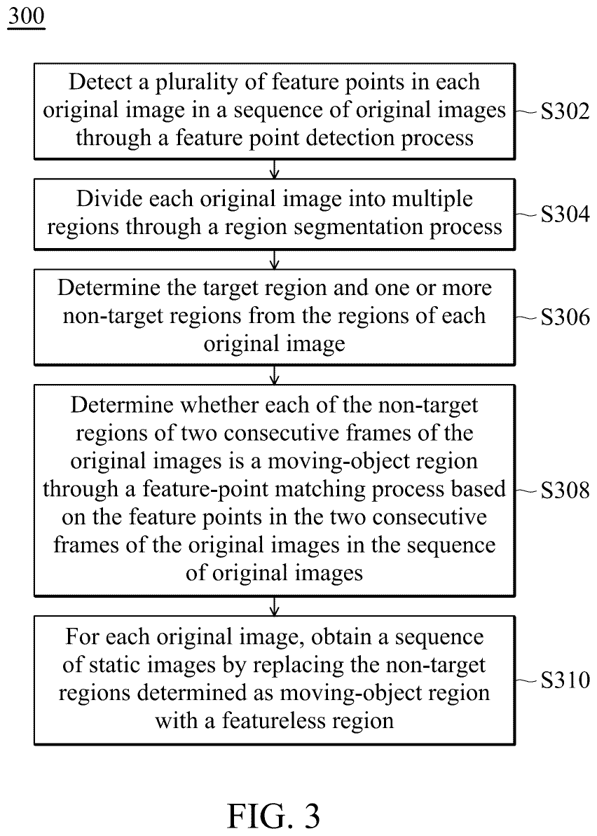

FIG. 3 is a flow diagram illustrating a method 300 for eliminating moving objects in 3D modeling, according to an embodiment of the present disclosure. As shown in FIG. 3, the method 300 may include steps S302-S310.

In step S302, a plurality of feature points in each original image in a sequence of original images are detected through a feature point detection process.

The original image sequence can be a sequence of images captured from different perspectives by a photography device mounted on a UAV, with moving objects not yet eliminated. The type of UAV or photography device, as well as the shooting scenarios, are not limited by the present disclosure.

Feature points can be understood as positions or regions in an image that are most recognizable, typically characterized by significant features such as brightness variations, textures, edges, colors, or shapes (e.g., having local extrema). It should be noted that due to changes in perspective (or the UAV's position), the distribution of feature points in different images within the original image sequence will vary, regardless of whether the captured scene is entirely static. In an embodiment, each feature point has a feature descriptor, which can be represented as a feature vector, to symbolize the gradients, orientations, and feature strengths around the feature point.

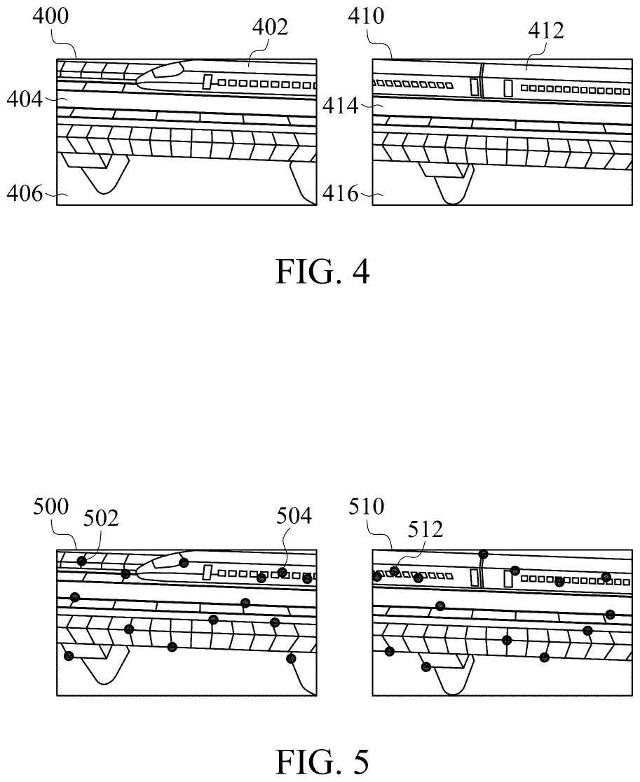

FIG. 4 illustrates two original images captured by a UAV flying from right to left, namely a first original image 400 and a second original image 410, according to an embodiment of the present disclosure. As shown in FIG. 4, the first original image 400 contains a train 402, a bridge 404, and the ground 406, while the second original image 410 contains a train 412, a bridge 414, and the ground 416. In this example, it is assumed that trains 402 and 412 are the same moving train captured at different times, while the bridge and ground are stationary. It can be observed from the first original image 400 and the second original image 410 that the train 412 exhibits significant changes in appearance compared to train 402.

FIG. 5 is a schematic diagram illustrating the first feature point detection result 500 and the second feature point detection result 510 for the first original image 400 and the second original image 410 after undergoing step S302, according to an embodiment of the present disclosure. As shown in FIG. 5, the upper-left portion of the first feature point detection result 500 contains feature points on the stationary bridge (such as feature point 502) and feature points on the moving train (such as feature point 504). However, the upper-left portion of the second feature point detection result 510 no longer contains feature points on the stationary bridge but instead contains feature points on the moving train, such as feature point 512. In other words, feature points on the stationary bridge are partially obscured by the moving train.

The feature point detection process in step S302 can be implemented using various feature detection algorithms or corner detectors, such as the Speeded Up Robust Features (SURF) algorithm, Accelerated-KAZE (KAZE) algorithm, Harris corner detector, Features from Accelerated Segment Test (FAST), Binary Robust Invariant Scalable Keypoints (BRISK), and others. In an embodiment, the feature point detection process is implemented using the Scale-Invariant Feature Transform (SIFT) algorithm. The concepts of the SIFTT algorithm involves convolving the image with Gaussian filters at different scales. This convolution is based on consecutive Gaussian-blurred images, resulting in Gaussian variance. This process is used to obtain feature points with scale and rotation invariance. Each feature point has a feature descriptor which can be represented as a feature vector to symbolize the gradients, orientation, and feature strength around the feature point. In practical operations, a single 3840×2160 image can yield around 50,000 SIFT feature points, with each SIFT feature point containing 128-dimensional information representing the gradient magnitude and gradient direction in the surrounding region.

Refer back to FIG. 3. In step S304, each original image is divided into multiple regions through a region segmentation process.

More specifically, the region segmentation process assigns an index value to each pixel in the original image, and pixels with the same index value form a single region. For example, pixels with index value “1” form the first region, pixels with index value “2” form the second region, and so forth. In other words, pixels in the first region have the index value “1”, pixels in the second region have the index value “2”, and so forth. This allows the subsequent steps to identify and process regions based on their index values.

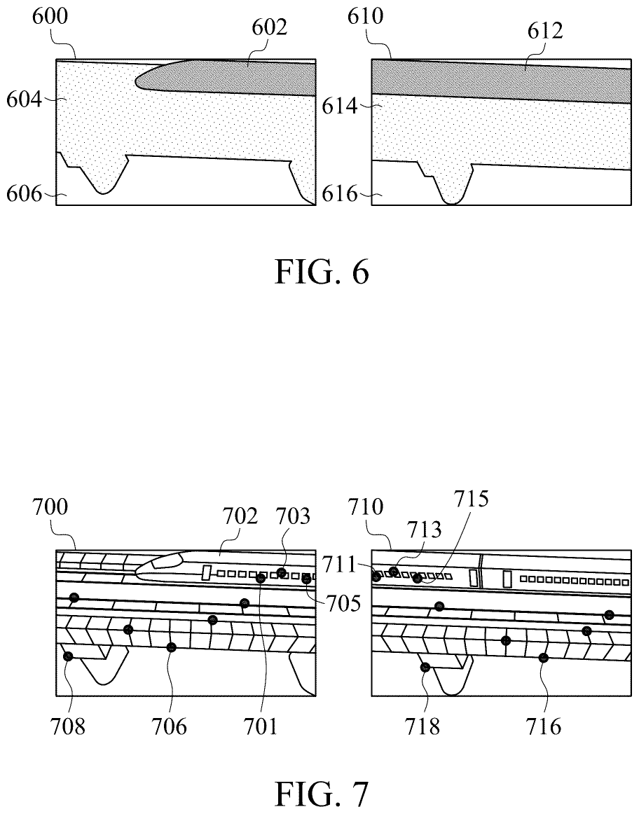

FIG. 6 is a schematic diagram showing the first region segmentation result 600 and the second region segmentation result 610 for the first original image 400 and the second original image 410 after undergoing step S304, according to an embodiment of the present disclosure. As shown in FIG. 6, the first region segmentation result 600 includes the train region 602, the bridge region 604, and the ground region 606, while the second region segmentation result 610 includes the train region 612, the bridge region 614, and the ground region 616. It should be noted that the naming of terms such as “train region,” “bridge region,” and “ground region” is merely for the reader's better understanding of the correspondence between the region segmentation results and the original images. However, in practice, these regions are identified by index values. The region segmentation process does not involve identifying the specific objects represented by these regions, such as trains, bridges, or ground.

The region segmentation process in step S304 can be implemented using algorithms such as Simple Linear Iterative Clustering (SLIC), Felzenszwalb's Graph-Based Segmentation, QuickShift, Region Growing, or any other algorithm commonly used for region segmentation. Alternatively, a convolutional neural networks (CNN)-based machine learning model, such as U-Net, SegNet, or Fully Convolutional Network (FCN) can be used to implement the region segmentation process. The training process for these models may involve acquiring labeled data, selecting a loss function, configuring optimization algorithms, among other common practices, but the present disclosure is not limited thereto. Additionally, it should be noted that the region segmentation model can be trained locally, or it can be trained on other computing devices (e.g., servers) and obtained via various means such as networks (e.g., downloading from the cloud), storage media (e.g., external hard drives), or other communication interfaces (e.g., USB), but the present disclosure is not limited thereto. In an embodiment, the region segmentation process is implemented using a Visual Transformer Adapter (ViT-Adapter). The Visual Transformer Adapter is a deep learning-based classifier that enhances the performance and generalization of the model by incorporating small neural network modules called “adapters” at various layers of a pre-trained visual transformer model.

Refer back to FIG. 3. In step S306, the target region and one or more non-target regions (i.e., regions other than the target region) are determined from the regions of each original image.

In an embodiment, the target region can be determined by enabling the user to select it from the region segmentation results presented in a graphical user interface (GUI). In another embodiment, a machine learning model specifically trained to recognize the target region, referred to as the target region recognition model, can be employed. In step S306, the trained target region recognition model can be used to identify the target region from the regions of each original image. The target region recognition model can be a CNN-based model, and its training process may involve acquiring labeled data, selecting a loss function, and configuring optimization algorithms, among other common practices, but the present disclosure is not limited thereto. Additionally, the target region recognition model can be trained locally, or it can be trained on other computing devices (e.g., servers) and obtained via various means such as networks (e.g., downloading from the cloud), storage media (e.g., external hard drives), or other communication interfaces (e.g., USB), but the present disclosure is not limited thereto.

For a modeling task, the target object for modeling is known in advance. For example, when modeling a bridge, the target would be the main structure of the bridge and its surrounding terrain. Using FIG. 6 as an example, the bridge region 604 can be selected as the target region. Due to the high overlap between the original images in the original image sequence (typically more than 50%), the index value of the original bridge region 604 can be further extended to the next original image's bridge region 614 based on the overlap ratio (e.g., considering only regions with more than 50% overlap). The bridge region 614 is then considered the target region for the second original image 410. In other words, by performing step S306 once, the target regions for the remaining original images in the original image sequence can be inferred based on the overlap.

Refer back to FIG. 3. In step S308, whether each of the non-target regions in two consecutive frames of the original images is a moving-object region (i.e., a region corresponding to a moving object) is determined through a feature-point matching process based on the feature points in these consecutive frames within the sequence of original images.

In an embodiment, the feature-point matching process involves comparing the feature descriptors in two images to identify similar feature points in both images. Feature points with matching descriptors form a matching pair. As mentioned earlier, feature descriptors can be represented as feature vectors, representing the gradient, orientation, and feature strengths around the feature point. Therefore, the feature-point matching process may further involve calculating the distance or similarity between two feature vectors, such as Euclidean distance, Manhattan distance, cosine similarity, or other measures used to represent distance or similarity, but the disclosure is not limited thereto.

FIG. 7 is a schematic diagram illustrating the matching pairs of feature points between the first original image 700 and the second original image 710, according to an embodiment of the present disclosure. The first original image 700 and the second original image 710 respectively correspond to the first feature point detection result 500 and the second feature point detection result 510 in FIG. 5, but not all the feature points plotted in FIG. 5 appear in FIG. 7. In the example of FIG. 7, only nine sets of similar feature points, namely nine matching pairs, found by the feature-point matching process of step S308, are shown. These include the first matching pair composed of feature point 701 in the first original image 700 and feature point 711 in the second original image 710; the second matching pair composed of feature point 703 in the first original image 700 and feature point 713 in the second original image 710; the third matching pair composed of feature point 705 in the first original image 700 and feature point 715 in the second original image 710; the fourth matching pair composed of feature point 706 in the first original image 700 and feature point 716 in the second original image 710; the fifth matching pair composed of feature point 708 in the first original image 700 and feature point 718 in the second original image 710, and the other four matching pairs not specifically marked with symbols. Among these matching pairs, the first, second, and third matching pairs are located on the moving train 702, while the fourth and fifth matching pairs are on the stationary bridge. As a result, feature point pairs 701 and 711, 703 and 713, 705 and 715, which correspond to the moving train 702, exhibit larger displacements compared to feature point pairs 706 and 716 or 708 and 718, indicating that the region corresponding to the train 702 is a moving-object region.

The feature-point matching process in step S308 can be implemented using algorithms such as nearest neighbor matching, random sample consensus (RANSAC), Kanade-Lucas-Tomasi feature tracker, or similar approaches. In an embodiment, the feature-point matching process is implemented using the Brute-Force Matcher (BFMatcher), which searches for the optimal match by calculating the distance or similarity between two sets of feature descriptors (or feature vectors).

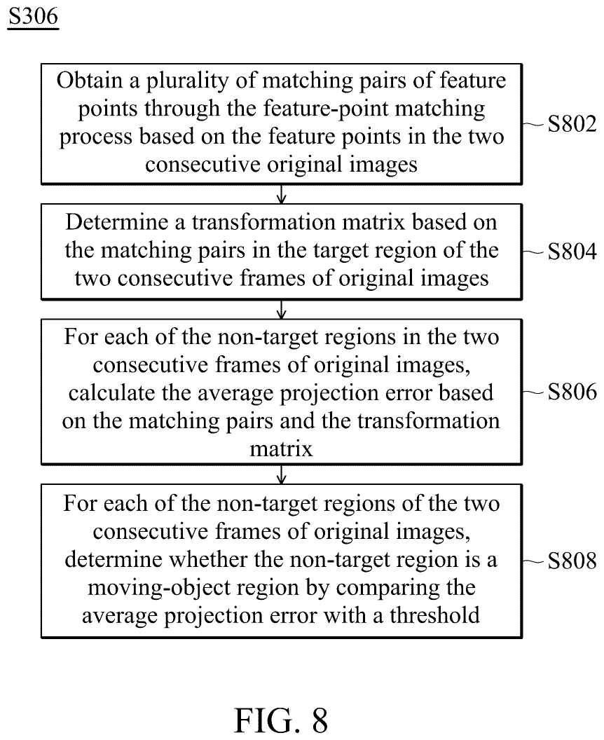

FIG. 8 is a flow diagram illustrating more detailed steps for determining the moving in step S308, according to an embodiment of the present disclosure. As shown in FIG. 8, step S308 may further include steps S802-S808.

In step S802, a plurality of matching pairs of feature points are obtained through the feature-point matching process based on the feature points in the two consecutive original images. Taking FIG. 7 as an example, after step S802, nine matching pairs are obtained for the first original image 700 and the second original image 710.

In step S804, a transformation matrix is determined based on the matching pairs in the target region of the two consecutive frames of original images.

The transformation matrix represents the transformation relationship between the feature points (as well as other pixels) in two original images. Therefore, step S804 can be understood as finding the transformation relationship of pixel positions in the target region of the two consecutive frames of original images. In the subsequent steps, by examining whether the transformation relationship in each non-target regions differs significantly from that of the target region, the moving-object region can be identified.

In step S806, for each of the non-target regions in the two consecutive frames of original images, the average projection error is calculated based on the matching pairs and the transformation matrix.

The average projection error represents the degree of dissimilarity between the pixel position transformation relationship in the non-target region and the pixel position transformation relationship in the target region. In other words, the larger the average projection error, the greater the difference between the pixel position transformation relationships in the non-target region and the target region.

In step S808, for each of the non-target regions of the two consecutive frames of original images, whether the non-target region is a moving-object region is determined by comparing the average projection error with a threshold.

More specifically, if the average projection error exceeds the threshold, indicating that there is a significant difference between the pixel position transformation relationship in the non-target region and the pixel position transformation relationship in the target region. Therefore, the non-target region is determined to be a moving-object region. The threshold can be a pre-defined numerical value or a variable determined through certain computations.

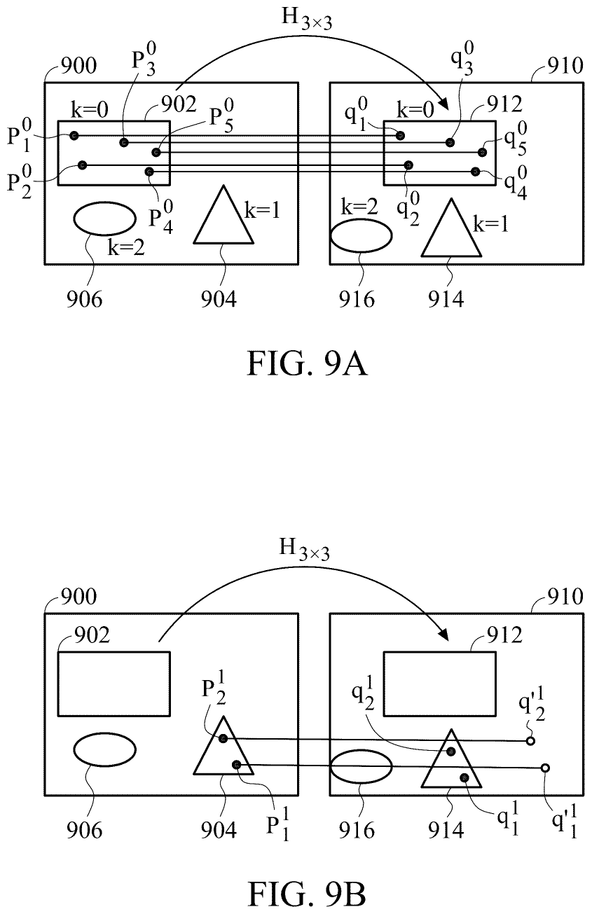

FIG. 9A and FIG. 9B are conceptual diagrams illustrating the use of the transformation matrix H_{3×3} to determine the moving-object regions, according to an embodiment of the present disclosure. As shown in FIG. 9A and FIG. 9B, the first original image 900 contains regions 902, 904, and 906, each corresponding to regions 912, 914, and 916 in the second original image 910. Regions 902 (and 912), 904 (and 914), and 906 (and 916) are assigned index values 0, 1, and 2, respectively, denoted as k. In this example, regions 902 and 912 with index value k=0 are designated as the target region, while other regions are considered non-target regions. Furthermore, let M^{k} represent the number of matching pairs in the region with index value k, and denote the i^{th} feature point in the region with index value k in the first original image 900 and the second original image 910 as pᵢ^{k} and qᵢ^{k}, respectively, where i=1, 2 . . . . M^{k}. As shown in FIG. 9A, the feature points p₁⁰, p₂⁰, p₃⁰, p₄⁰, and p₅⁰ in the target region 902 each form matching pairs with the corresponding feature points q₁⁰, q₂⁰, q₃⁰, q₄⁰, and q₅⁰ in the target region 912, resulting in M^{k}=5. Furthermore, let X(pᵢ^{k}) and Y(pᵢ^{k}) represent the X and Y coordinates of pᵢ^{k} in the first original image 900, and X(qᵢ^{k}) and Y(qᵢ^{k}) represent the X and Y coordinates of qᵢ^{k} in the second original image 910. In step S804, the transformation matrix H_{3×3} can be determined based on these five matching pairs (p₁⁰, q₁⁰), (p₂⁰, q₂⁰), (p₃⁰, q₃⁰), (p₄⁰, q₄⁰), (p₅⁰, q₅⁰), representing the pixel position transformation relationship between the target region 902 and the target region 912.

The determination of the transformation matrix H_{3×3} involves the concept of searching for an optimal transformation matrix H_{3×3} such that, for each feature point in the target region (i.e., i=1 to M^{k}), the following <Formula 1> is satisfied as much as possible.

$$[ \begin{matrix}X ( {q}_{i}^{0} ) \\ Y ( {q}_{i}^{0} ) \\ 1\end{matrix} ] = {H}_{3 \times 3} [ \begin{matrix}X ( {p}_{i}^{0} ) \\ Y ( {p}_{i}^{0} ) \\ 1\end{matrix} ] \qquad < Formula 1 >$$

Next, in step S806, for each of the non-target regions of the first original image 900 (i.e., regions with index k≠0), the feature points pᵢ^{k} can be projected onto the corresponding projection points q′ᵢ^{k} in the second original image 910 using the following <Formula 2>.

$$[ \begin{matrix}X ( {q}_{i}^{′ k} ) \\ Y ( {q}_{i}^{′ k} ) \\ 1\end{matrix} ] = {H}_{3 \times 3} [ \begin{matrix}X ( {p}_{i}^{k} ) \\ Y ( {p}_{i}^{k} ) \\ 1\end{matrix} ] \qquad < Formula 2 >$$

As shown in FIG. 9B, through the transformation matrix H_{3×3}, the feature points p₁¹ and p₂¹ in the non-target region 904 of the first original image 900 can be projected onto the corresponding projection points q′₁¹ and q′₂¹ in the second original image 910.

Subsequently, the Euclidean distance between the projection points q′t in the second original image 910 and the feature points qᵢ^{k} can be calculated as the projection error. Then, the average of all projection error values can be calculated, as shown in the following <Formula 3>.

$${E}^{k} = {\sum }_{i = 1}^{{M}^{k}} \sqrt{{( X ( {q}_{i}^{k} ) - X ( {q}_{i}^{′ k} ) )}^{2} + {( Y ( {q}_{i}^{k} ) - Y ( {q}_{i}^{′ k} ) )}^{2}} / {M}^{k} \qquad < Formula 3 >$$

Taking FIG. 9B as an example, the calculation of the average projection error value E¹ for the non-target regions 904 and 914 with index value k=1 is as follows:

$${E}^{1} = \frac{\begin{matrix}\sqrt{{( X ( {q}_{1}^{1} ) - X ( {q}_{1}^{′ 1} ) )}^{2} + {( Y ( {q}_{1}^{1} ) - Y ( {q}_{1}^{′1} ) )}^{2}} + \\ \sqrt{{( X ( {q}_{2}^{1} ) - X ( {q}_{2}^{′1} ) )}^{2} + {( Y ( {q}_{2}^{1} ) - Y ( {q}_{2}^{′ 1} ) )}^{2}}\end{matrix}}{2}$$

In an embodiment, the determination of the transformation matrix H_{3×3} can involve the use of algorithms related to function fitting, such as the least squares method, Least Absolute Deviations (LAD), least squares support vector machine (LS-SVM), polynomial fitting, among others, but the present disclosure is not limited thereto.

In an embodiment, before step S808, the average projection error and the corresponding standard deviation in the target region of the two consecutive frames of the original images (i.e., the average and standard deviation of the projection errors of the feature points in the target region) can be calculated based on the matching pairs in the target region of the two consecutive frames of the original images and the transformation matrix. More specifically, the calculation of the standard deviation σ is as shown in the following <Formula 4>.

$$σ = \sqrt{\frac{{\sum }_{i = 1}^{{M}^{0}} {( \sqrt{\begin{matrix}{( X ( {q}_{i}^{0} ) - X ( {q}_{i}^{′0} ) )}^{2} + \\ {( Y ( {q}_{i}^{0} ) - Y ( {q}_{i}^{′0} ) )}^{2}\end{matrix}} - {E}^{0} )}^{2}}{{M}^{0} - 1}} \qquad < Formula 4 >$$

Subsequently, based on the calculated average projection error and standard deviation, the threshold used for comparison with the average projection error in step S808 is determined. In a preferred embodiment, the threshold is set to the sum of the average projection error E° and twice the standard deviation. For example, if the average projection error E° for the target region is 75 and the standard deviation is 50.4, then the threshold would be 75+2×50.4=175.8. Using FIGS. 9A and 9B as an example, the average projection error E° and its corresponding standard deviation for the target regions 902 and 912 can be calculated, and then used to determine the respective threshold Tₚ. If the average projection error E¹ for the non-target regions 904 and 914 exceeds Tₚ, then the non-target regions 904 and 914 are determined to be moving-object regions.

In an embodiment, before proceeding to step S804, the homography relationship of the target region of the two consecutive frames of the original images can be examined based on the number of matching pairs in the target region of the two consecutive frames of the original images. If the target region has a homography relationship in the two consecutive frames of the original images, then the condition for determining the transformation matrix in step S804 is met. Otherwise, steps S804 to S808 are skipped. In other words, it is considered that no moving-object region is detected from the two consecutive frames of the original images.

In the context mentioned, the term “homography relationship” refers to a reversible transformation from a real projective plane to a projective plane. In the case of capturing stationary objects from a distance, two consecutive frames of the original images can be considered approximately coplanar. Therefore, theoretically, the static region (represented by the target region) in the first frame of the original image should be transformable into the corresponding region in the second frame of the original image based on the homography relationship.

Refer back to FIG. 3. In step S310, for each original image, a sequence of static images is obtained by replacing the non-target regions determined as moving-object regions with a featureless region.

The term “featureless region” refers to a region where the pixels do not possess any distinctive features. Typically, a solid color (such as white) can be used as a featureless region.

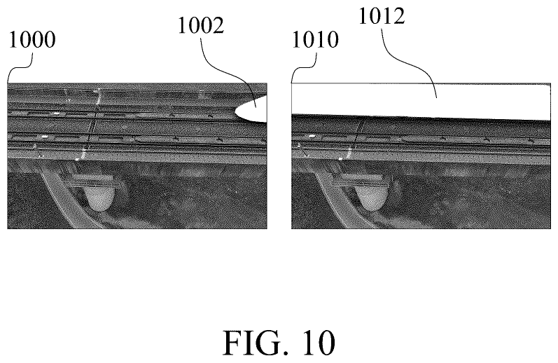

FIG. 10 shows an example of two static images 1000 and 1010 obtained after undergoing step S310, according to an embodiment of the present disclosure. As shown in FIG. 10, the region manifesting the outline of the train (such as the locomotive and carriages) in the static images 1000 and 1010 have been replaced with featureless regions 1002 and 1012, represented by pure white color.

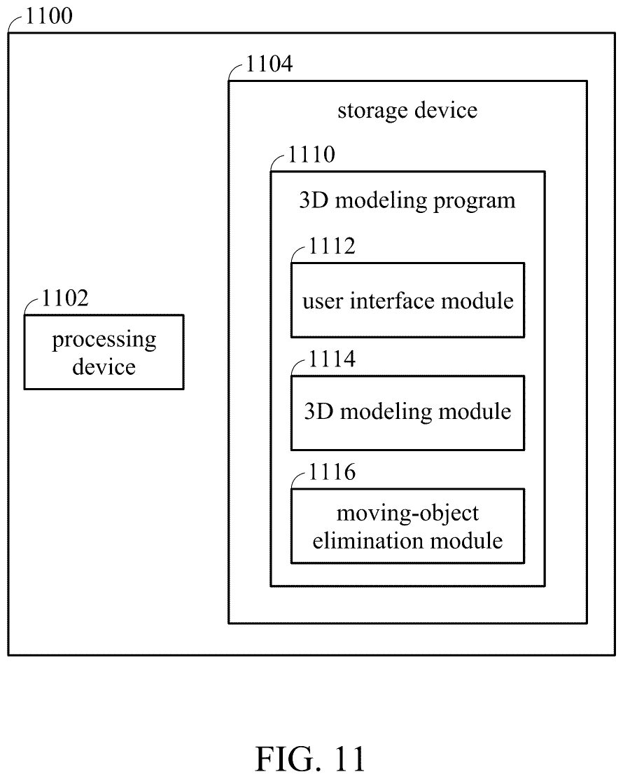

FIG. 11 is a system block diagram illustrating a computer system 1100 for 3D modeling, according to an embodiment of the present disclosure. As shown in FIG. 11, the computer system 1100 may include a processing device 1102 and a storage device 1104.

The computer system 1100 can be a personal computer (such as a desktop or laptop computer) or a server computer running an operating system (such as Windows, Mac OS, Linux, UNIX, among others). Alternatively, the computer system 1100 can also be a mobile device such as a tablet or smartphone, but the present disclosure is not limited thereto.

The processing device 1102 may include one or more general-purpose or specialized processors, or a combination thereof, capable of executing instructions. In various embodiments of the present disclosure, the processing device 1102 is configured to execute the aforementioned method for eliminating moving objects, such as the method 300. In an embodiment, the processing device 1102 may also include a Central Processing Unit (CPU) and a Graphics Processing Unit (GPU), although they are not shown in FIG. 11. A GPU is specifically designed to perform computer graphics calculations and image processing, making it more efficient for these tasks compared to a general-purpose CPU. Therefore, in various embodiments of the disclosure, tasks may be assigned based on the characteristics of the CPU and GPU, such as assigning tasks related to data acquisition or communication with other devices to the CPU and tasks related to computer graphics calculations and image processing to the GPU. In further embodiments, the processing device 1102 may further include a Neural Processing Unit (NPU) optimized for deep learning, although it is not shown in FIG. 11. Compared to a GPU, an NPU may offer superior computational performance for tasks related to operating the aforementioned region segmentation model and/or target region recognition model. Therefore, in this embodiment, tasks involving these machine learning models may be assigned to the NPU.

The storage device 1104 may include volatile memory such as Random Access Memory (RAM), Dynamic Random Access Memory (DRAM), Static Random Access Memory (SRAM)) and/or any one or more types of device containing non-volatile memory such as read-only memory, electrically-erasable programmable read-only memory (EEPROM), flash memory, non-volatile random access memory (NVRAM), such as hard disk drives (HDD), solid-state drives (SSD), optical disk, or any combination thereof, but the present disclosure is not limited thereto. In various embodiments of the disclosure, the storage device 1104 is used for storing the program corresponding to the aforementioned method for eliminating moving objects. When the processing device 1102 loads this program from the storage device 1104, the method for eliminating moving objects can be executed.

In an embodiment depicted in FIG. 11, the storage device 1104 stores a computer program product for 3D modeling, herein referred to as “3D modeling program” 1110. As shown in FIG. 11, the 3D modeling program 1110 may include a user interface module 1112, a 3D modeling module 1114, and a moving-object elimination module 1116. The user interface module 1112 is used for providing a user interface, the 3D modeling module 1114 is used for creating a 3D model, and the moving-object elimination module 1116 is used for executing the aforementioned method for eliminating moving objects, such as method 300. The processing device 1102 can load and run the 3D modeling program 1110 from the storage device 1104 to execute the user interface module 1112, the 3D modeling module 1114, and the moving-object elimination module 1116, as well as other basic operations of the 3D modeling program 1110.

In an embodiment, the processing device 1102 can be coupled to a display device to display the user interface provided by the user interface module 1112. The display device can be any device used to display visible information, such as an LCD display, LED display, OLED display, or plasma display, but the present disclosure is not limited thereto.

The user interface provided by the user interface module 1112 can be a graphical user interface (GUI), command line interface (CLI), touch interface, or voice interface, but the present disclosure is not limited thereto.

The 3D modeling module 1114 may involve any well-known 3D modeling techniques, such as stereo correspondence, point cloud reconstruction, point cloud processing, 3D rendering, etc., but the present disclosure is not limited thereto.

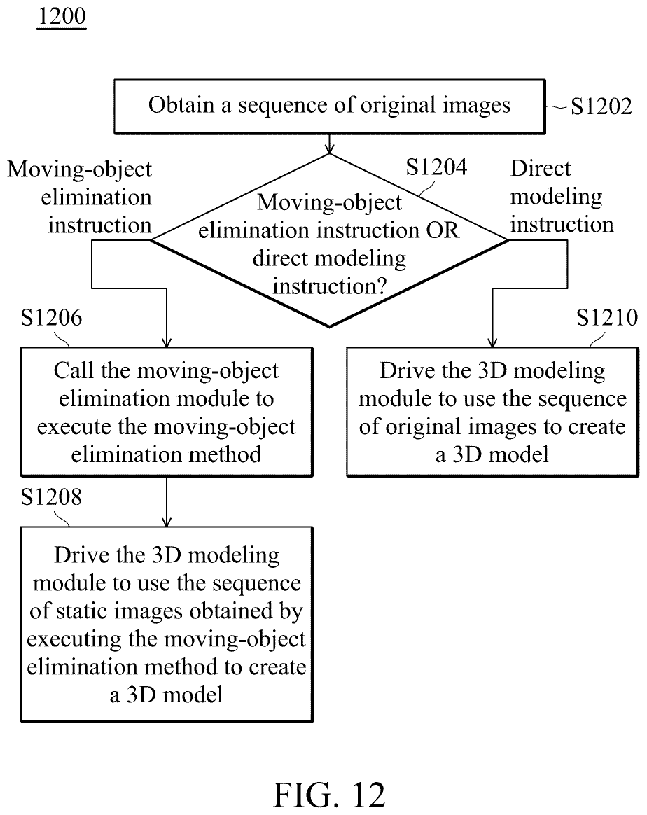

FIG. 12 is a flow diagram illustrating the basic operation 1200 of the 3D modeling program 1110, according to an embodiment of the present disclosure. As shown in FIG. 12, the basic operation 1200 of the 3D modeling program 1110 may include steps S1202-S1210.

In step S1202, a sequence of original images is obtained.

As mentioned earlier, the sequence of original images can be a series of images captured from different perspectives by a camera device mounted on a UAV, with moving objects not yet been eliminated. The sequence of original images can be obtained through a network, storage media, or other various communication interfaces, but the present disclosure is not limited thereto.

In step S1204, the user interface module 1112 receives instructions from the user of the computer system 1100 through the user interface. In response to receiving a moving-object elimination instruction, step S1206 is performed. In response to receiving a direct modeling instruction, step S1210 is performed.

In step S1206, the moving-object elimination module 1116 is called to execute the moving-object elimination method, such as method 300.

In step S1208, the 3D modeling module 1114 is driven to use the sequence of static images obtained by executing the moving-object elimination method to create a 3D model.

In step S1210, the 3D modeling module 1114 is driven to use the sequence of original images to create a 3D model.

In an embodiment, the user interface provided by the user interface module 1112 is a graphical user interface (GUI), presenting the region segmentation results of the region segmentation process, such as the first region segmentation result 600 and the second region segmentation result 610 shown in FIG. 6. This interface enables users of the computer system 1100 to select the target region on the region segmentation results. In this way, the moving-object elimination module 1116 can identify the target region in step S306 and classify other regions as non-target regions. Additionally, various GUI elements or widgets such as checkboxes, toggle switches, drop-down lists, or the like may be provided on the graphical user interface for the user to select the moving-object elimination instruction or direct modeling instruction. However, the specific graphic design and configuration of the graphical user interface is not limited by the present disclosure.

If the movement speed of an object is too slow, causing it to constantly obscure the target region in the original image sequence, the accuracy of 3D modeling may also be compromised. In view of this, in an embodiment, the moving-object elimination module 1116 can further detect the area proportion (i.e., percentage of the area) of the moving-object region in the sequence of original images, and check the number of original images in the original image sequence that are determined to be without any moving-object regions. If the area proportion of the moving-object region in the sequence of original images exceeding a first specified threshold, and the number of original images in the original image sequence that are determined to be without moving-object regions being below a second specified threshold, the moving-object elimination module 1116 will notify the user interface module 1112 to present an exception message in the user interface. The exception message can be set to guide the user to manually eliminate moving objects or add more original images (e.g., images taken at other time when slow-moving objects are not present) to facilitate 3D modeling.

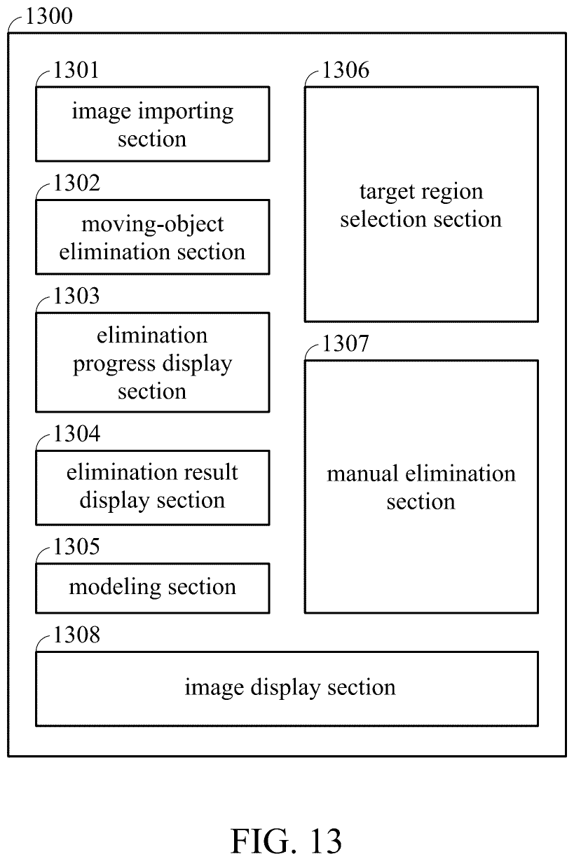

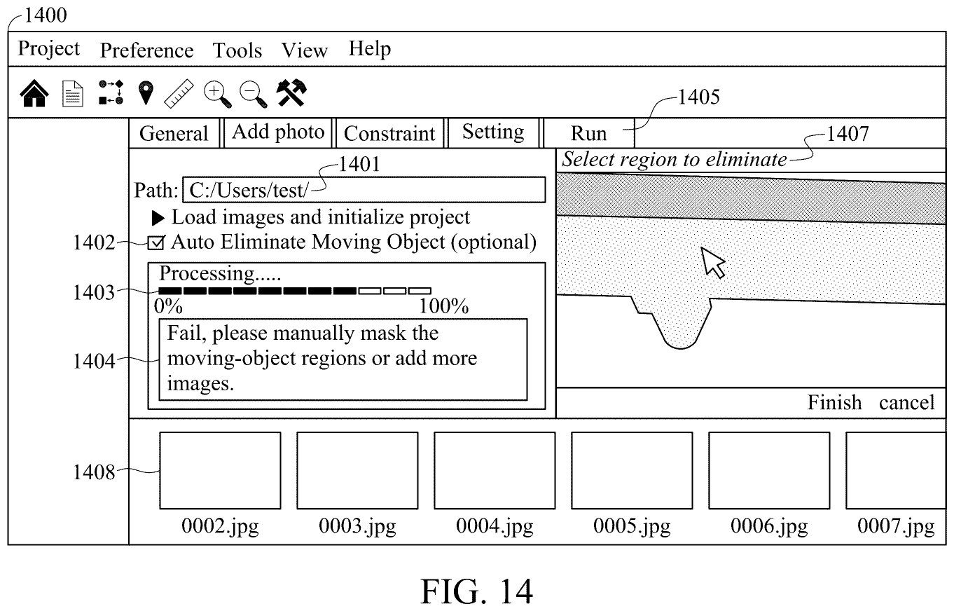

FIG. 13 is an interface block diagram illustrating a user interface 1300 that can be provided when a 3D modeling program is loaded into a computer, according to an embodiment of the present disclosure. Correspondingly, FIG. 14 is an illustrative example of the user interface 1400 provided by the 3D modeling program when the exception event is triggered. Please refer to FIG. 13 and FIG. 14 together to get a better understanding of the embodiments of the present disclosure.

The user interface 1300 at least includes an image importing section 1301, a moving-object elimination section 1302, and a modeling section 1305 shown in FIG. 13. Correspondingly, the user interface 1400 at least includes the image importing section 1401, the moving-object elimination section 1402, and the modeling section 1405 shown in FIG. 14.

The image importing parts 1301 and 1401 enable users to input a specified path, such as “C:/Users/3DModeling/RawData” or other similar paths, so as to import the original image sequence from the path. The image importing units 1301 and 1401 may be implemented using GUI elements or widgets such as a file chooser dialog, a text box, a file drag and drop, a tree view, among others, but the present disclosure is not limited thereto.

The moving-object elimination sections 1302 and 1402 enable users to input elimination instructions. The elimination instructions are used to indicate whether the moving-object elimination method (such as the moving-object elimination method 300 in FIG. 3) should be enabled, and to trigger the execution of the moving-object elimination method. In response to receiving the elimination instruction input by the user through the moving-object elimination section 1302 or 1402, the 3D modeling program causes the computer to perform the moving-object elimination method on the original image sequence imported from the specified path (i.e., input by the user through the image importing unit 1301 or 1401). The moving-object elimination sections 1302 and 1402 may be implemented using GUI elements or widgets such as a check box, a switch, or a drop-down menu, together with a confirmation button or a start button, but the present disclosure is not limited thereto.

The modeling parts 1305 and 1405 enable users to input modeling instructions. The modeling instructions are used to trigger the 3D modeling process. In response to receiving the modeling instruction, the 3D modeling program causes the computer to select, based on the elimination instruction, either the original image sequence or the static image sequence for use in creating a 3D model. More specifically, if the elimination instruction indicates that the moving-object elimination method is enabled, the static image sequence is used to create the 3D model. Otherwise, if the elimination instruction indicates that the moving-object elimination method is disabled, the original image sequence is used to create the 3D model. The modeling parts 1305 and 1405 may be implemented using GUI elements or widgets such as a confirmation button, a start button, a toolbar button, a menu option, among others, but the present disclosure is not limited thereto.

In an embodiment, the user interfaces 1300 and 1400 may further include elimination progress display parts 1303 and 1403. The elimination progress display parts 1303 and 1403 are used to present the processing progress of the moving-object elimination method. The processing progress can be indicated by a completion rate, such as 20%, 50%, 90%, or by status text expression such as “processing” or “completed”. The elimination progress display parts 1303 and 1403 may be implemented using GUI elements or controls such as a progress bar, a circular progress bar, a digital display, a status label, a timeline, among others, but the present disclosure is not limited thereto.

In an embodiment, the user interface 1300 may further include a target region selection section 1306. The target region selection section 1306 is used to present the region segmentation results, such as the first region segmentation result 600 and the second region segmentation result 610 shown in FIG. 6, enabling users to select the target region on the region segmentation result. As an illustrative example, the selection and elimination section 1407 of the user interface 1400 can be used to present the region segmentation result, enabling users to select a target region on the region segmentation result.

In an embodiment, the user interfaces 1300 and 1400 may further include image display parts 1308 and 1408. The image display parts 1308 and 1408 are used to present the original image sequence and/or static image sequence.

In an embodiment, the user interfaces 1300 and 1400 may further include elimination result display parts 1304 and 1404. When the moving-object elimination method is successfully executed and the static image sequence is obtained, the elimination result display parts 1304 and 1404 present a success message. The success message informs the user that the moving objects (or moving-object regions) in the original image sequence have been eliminated. For example, the success message might read, “13 moving-object regions in 105 images have been successfully eliminated.” If an exception event occurs—specifically, if the area proportion of the moving-object region in the original image sequence exceeds the first specified threshold, and the number of the original images without moving-object regions is below the second specified threshold—the elimination result display parts 1304 and 1404 display an exception message. The exception message informs the user that the moving-object elimination method encountered an exception event (e.g., the moving object constantly obscures the target region) and was unsuccessful. In a further embodiment, the exception message may be configured to guide the user to add more original images (e.g., images taken at a different time when slow-moving objects are not present) to the original image sequence. In another embodiment, the exception message may be configured to guide the user to manually eliminate the moving objects. After the exception message is presented, the user interface 1300 may further include a manual elimination section 1307, enabling users to manually eliminate the moving objects. As an illustrative example, the selection and elimination section 1407 of the user interface 1400 can be used to enable the user to manually eliminate the moving objects after the exception message is presented.

The various embodiments disclosed herein provide a solution for eliminating moving objects in 3D modeling, with spatial (object) and temporal (movement) awareness. By selectively eliminating moving objects from images while retaining information about stationary objects, the integrity and accuracy of the 3D model are ensured. Additionally, the disclosed user interface further offers flexibility in enabling or disabling the moving-object elimination process, allows users to select target regions on the region segmentation results, and displays elimination results, providing user interaction features distinct from traditional 3D modeling approaches. In contrast to some post-modeling denoising processes, the embodiments disclosed herein eliminate objects before modeling, further preventing the introduction of noise into the 3D model. The images with moving objects eliminated can be seamlessly integrated into various commercial modeling software, enhancing their market applicability.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A moving-object elimination method for 3D modeling, comprising the following steps:
detecting a plurality of feature points in each original image in a sequence of original images through a feature point detection process;
dividing each original image into a plurality of regions through a region segmentation process;
determining a target region and one or more non-target regions from the regions of each original image;
determining whether each of the non-target regions of two consecutive frames of original images is a moving-object region through a feature-point matching process based on the feature points in the two consecutive frames of original images in the sequence of original images; and
replacing, for each original image, the non-target regions determined as the moving-object regions with a featureless region, to obtain a sequence of static images.

2. The moving-object elimination method as claimed in claim 1, wherein the step of determining whether each of the non-target regions of the two consecutive frames of original images is a moving-object region through the feature-point matching process based on the feature points in the two consecutive frames of original images in the sequence of original images further comprises:
obtaining a plurality of matching pairs of feature points through the feature-point matching process based on the feature points in the two consecutive original images;
determining a transformation matrix based on the matching pairs in the target region of the two consecutive frames of original images;
calculating an average projection error for each of the non-target regions of the two consecutive frames of the original image based on the matching pairs in the non-target region and the transformation matrix; and
determining, for each of the non-target regions of the two consecutive original images, whether the non-target region is a moving-object region, by comparing the average projection error with a threshold.

3. The moving-object elimination method as claimed in claim 2, before determining the transformation matrix, the method further comprising:
examining a homography relationship of the target region in the two consecutive original images based on number of matching pairs in the target region of the two consecutive original images.

4. The moving-object elimination method as claimed in claim 2, wherein the step of calculating the average projection error for each of the non-target regions of the two consecutive frames of the original image based on the matching pairs in the non-target region and the transformation matrix further comprises:
for each of the matching pairs in the non-target region, using the transformation matrix to project the first feature point in the matching pair to a projection point, and calculating a Euclidean distance between the projection point and the second feature point in the matching pair; and
calculating an average of the Euclidean distances of the matching pairs, and using the calculated average as the average projection error.

5. The moving-object elimination method as claimed in claim 2, wherein before comparing the average projection error with the threshold, the method further comprises:
calculating the average projection error and a corresponding standard deviation for the target region of the two consecutive original images based on the matching pairs in the target region and the transformation matrix; and
determining the threshold based on the average projection error and the standard deviation of the target region of the two consecutive frames of original images.

6. The moving-object elimination method as claimed in claim 1, wherein each feature point has a feature descriptor.

7. The moving-object elimination method as claimed in claim 6, wherein the feature-point matching process comprises comparing the feature descriptors in the two consecutive frames of original images to obtain a plurality of matching pairs of feature points.

8. The moving-object elimination method as claimed in claim 6, wherein the feature point detection process comprises using a scale-invariant feature transform (SIFT) algorithm.

9. The moving-object elimination method as claimed in claim 1, wherein the region segmentation process comprises using a ViT-Adapter.

10. The moving-object elimination method as claimed in claim 1, wherein the feature-point matching process comprises using a Brute-Force Matcher.

11. A computer program product for 3D modeling, comprising:
a user interface module, for providing a user interface;
a 3D modeling module, for creating a 3D model; and
a moving-object elimination module, for executing the moving-object elimination method as claimed in claim 1;
wherein when the computer program product is loaded into a computer, the computer is capable of executing the following steps:
obtaining a sequence of original images;
in response to receiving a moving-object elimination instruction from the user interface, calling the moving-object elimination module to execute the moving-object elimination method, and driving the 3D modeling module to use the sequence of static images obtained by executing the moving-object elimination method to create the 3D model; and
in response to receiving a direct modeling instruction from the user interface, driving the 3D modeling module to use the sequence of original images to create the 3D model.

12. The computer program product as claimed in claim 11, wherein the user interface is a graphical user interface (GUI) for presenting a region segmentation result of the region segmentation process and enabling the user of the computer to select the target region on the segmentation result.

13. The computer program product as claimed in claim 11, wherein the moving-object elimination module further detects an area proportion of the moving-object region in the sequence of original images, and checks number of the original images in the original image sequence that are determined to be without the moving-object regions;
in response to the area proportion of the moving-object region in the sequence of original images exceeding a first specified threshold, and the number of the original images in the original image sequence that are determined to be without moving-object regions being below a second specified threshold, the moving-object elimination module notifies the user interface module to present an exception message in the user interface.

14. A computer program product for 3D modeling that, when loaded into a computer, provides a graphical user interface (GUI) which includes:
an image importing section, enabling a user to input a specified path to import an original image sequence;
a moving-object elimination section, enabling the user to input an elimination instruction; and
a modeling section, enabling the user to input a modeling instruction;
wherein in response to receiving the elimination instruction, the computer program product causes the computer to execute a moving-object elimination method on the original image sequence to obtain a static image sequence; and
wherein in response to receiving the modeling instruction, the computer program product causes the computer to select, based on the elimination instruction, either the original image sequence or the static image sequence, for use in creating a 3D model.

15. The computer program product as claimed in claim 14, wherein the graphical user interface further includes an elimination progress display section, for presenting a processing progress of the moving-object elimination method.

16. The computer program product as claimed in claim 14, wherein the graphical user interface further includes a target region selection section, presenting a region segmentation result and enabling the user to select a target region on the region segmentation result.

17. The computer program product as claimed in claim 14, wherein the graphical user interface further includes an image display section, presenting the original image sequence, the static image sequence, or both.

18. The computer program product as claimed in claim 14, wherein the graphical user interface further includes an elimination result display part;
in response to the area proportion of a moving-object region in the original image sequence exceeding a first specified threshold, and the number of the original images in the original image sequence that are determined to be without moving-object regions being below a second specified threshold, the elimination result display section presents an exception message; and
in response to obtaining the static image sequence, the elimination result display section presents a success message.

19. The computer program product as claimed in claim 18, wherein after the exception message is presented, the graphical user interface further includes a manual elimination section, enabling the user to manually eliminate the moving objects.

20. The computer program product as claimed in claim 18, wherein the exception message is configured to guide the user to add more original images to the original image sequence.
